(19) United States
(12) Patent Application Publication
(10) Pub. No.: US 2012/0060283 A1
(43) Pub. Date: Mar. 15, 2012

(54) Bed Sheet with Indicia and Method

(76) Inventor: Stephanie Campasano, Holmdel, NJ (US)

(21) Appl. No.: 13/300,562

(22) Filed: Nov. 19, 2011

Related U.S. Application Data
(63) Continuation-in-part of application No. 12/802,793, filed on Jun. 14, 2010.

(51) Int. Cl. A47G 9/02; G09F 3/00

(52) U.S. Cl. 5/495

(57) ABSTRACT

A user placement system for a bed is provided that includes a bed sheet and a user indicating indicia carried by the bed sheet. When the bed sheet is located on the bed before being used by the user the user indicating indicia may designate a location of a part of the user when the user sleeps on the bed. An associated method may also be provided.

### CROSS REFERENCE TO RELATED APPLICATIONS

This application is a continuation-in-part and claims the benefit of U.S. application Ser. No. 12/802,793 filed on Jun. 14, 2010 and entitled, “Bed Sheet with Indicia and Method” that is incorporated by reference herein in its entirety for all purposes.

### FIELD OF THE INVENTION

The present invention relates generally bed sheets having indicia. More particularly, the present application involves a system and method for placement of a head indicating indicia onto a bed sheet that can be used to assist a user in properly orienting the bed sheet with respect to the head of the bed when making up the bed.

### BACKGROUND

Bed sheets such as bottom sheets, top sheets, and covers are commonly employed in a bed. Bed sheets are often not symmetrical or have specific top and bottom surfaces so that they must be oriented properly when being applied to the bed. The toe end of the bed sheet may be configured differently from the head end of the bed sheet in some instances. A person making a bed thus expends a significant amount of time and energy to distinguish the upper surface of the bed sheet and to determine which end of the bed sheet should be located at the head of the bed.

Prior systems for placing indicia on bed sheets involved the manufacture of bed sheets that had colored yarn incorporated into the hem of the bed sheet. The color of the yarn instructed the user as to the size of the bed sheet so that the user can retrieve a correctly sized bed sheet when making up a bed. However, such indicia cannot be applied by a user or provide insight as to the orientation of the bed sheet on the bed or as to the proper upper surface of the bed sheet. A different indication system in use for making a bed includes the provision of a center indicator onto the bed sheet that is aligned with a corresponding center indicator on a head board or base board of a bed. Once aligned, an equal amount of the bed sheet will be draped over the left side of the bed as the right side of the bed. However, such a system requires a head board or base board be present, requires a mark be made on these portions of the bed, and does not provide insight as to other items such as which surface of the bed sheet is the top surface. Further, such a system requires an equal amount of bed sheet be placed on both the right and left hand sides of the bed and does not account for the possibility that a user or users of a bed would want more or less covers available on different sides during use. Also, such a system requires a user purchase a new bed sheet that incorporates indicia associated with such a system as opposed to using his or her existing bed sheets. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a top plan view of a head placement system with a bed sheet having a head indicating indicia thereon in accordance with one exemplary embodiment.

FIG. 2 is a top plan view of a mattress showing the location of the user with respect to the mattress when using the mattress in accordance with one exemplary embodiment.

FIG. 3 is a top plan view of the bed sheet of FIG. 1 located onto the mattress of FIG. 2 and having a user located thereon.

FIG. 4 is a cross-sectional view taken along line 3-3 of FIG. 3.

FIG. 5 is a top plan view of a head placement system in accordance with another exemplary embodiment.

FIG. 6 is a top plan view of a head placement system in accordance with yet another exemplary embodiment.

FIG. 7 is a cross-sectional view of a user placement system in accordance with another exemplary embodiment.

FIG. 8 is a cross-sectional view of a user placement system in accordance with a still further exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a head placement system 10 that functions to instruct a user 26 as to the correct orientation and placement of a bed sheet 12 with respect to the head of a bed 66. The user 26 can thus make up the bed 66 in a faster and more efficient manner since the proper orientation and placement of the bed sheet 12 on the bed 66 is readily apparent. Head indicating indicia 24 is located on the upper surface 14 of the bed sheet 12 to instruct the user 26 as to which side of the bed sheet 12 is the upper surface 14, and to instruct the user 26 as to which edge of the bed sheet 12 it to be positioned adjacent a head board 72 of the bed 66. The bed sheet 12 may be symmetrical or the top portion of the bed sheet 12 may be constructed differently than the bottom portion of the bed sheet 12 thus making it desirable to properly orient the bed sheet 12 on the bed 66. In a further exemplary embodiment, the location of the head indicating indicia 24 provides a reference point to the user 26 as to where the user's head 28 will be located during use of the bed 66. Pillows 76 can thus be placed in relation to the head indicating indicia 24 in order to more efficiently and accurately make up the bed 66 after use.

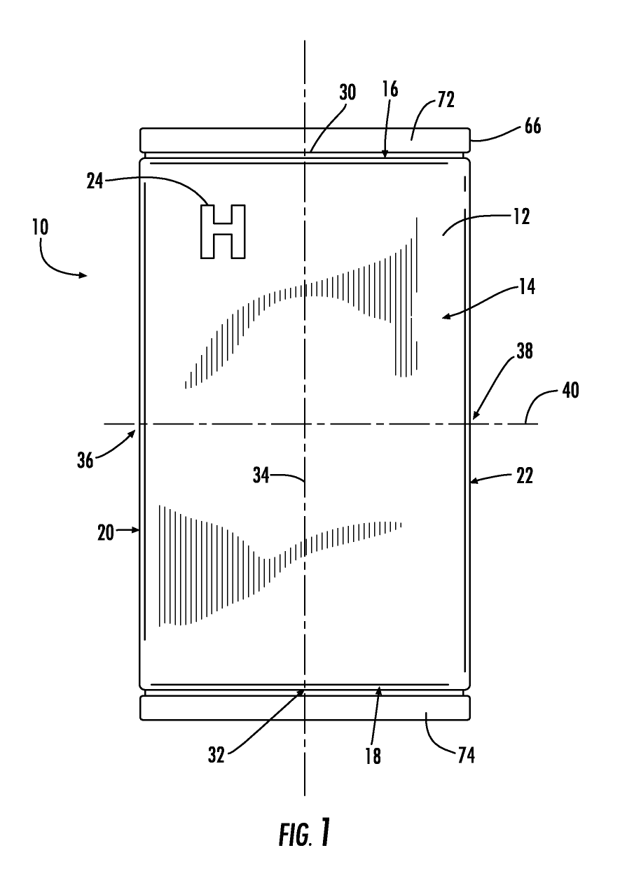

A head placement system 10 shown in accordance with one exemplary embodiment is illustrated in FIG. 1. The head placement system 10 includes a bed sheet 12 that is incorporated into a bed 66 that may have a head board 72 and a foot board 74, although it is to be understood that the bed 66 need not have a foot board 74 and/or head board 72 in other embodiments. The bed sheet 12 has an upper surface 14 that faces generally towards the ceiling of the room into which the bed 66 is located. It is to be understood; however, that certain portions of the upper surface 14 will not face towards the ceiling as portions of the upper surface 14 will be draped over the side of the bed 66 or will be tucked under a mattress 42 and hence inverted. The bed sheet 12 can be a bottom sheet in one exemplary embodiment and may be either a fitted sheet or a flat bed sheet.

The bed sheet 12 has a head edge 16 located on one end and an oppositely disposed toe edge 18 located on an opposite end. A first side edge 20 extends from the head edge 16 to the toe edge 18 and is located on one side of the bed sheet 12. A second side edge 22 is located on the opposite side of the bed sheet 12 and likewise extends from the head edge 16 to the toe edge 18. The head edge 16 is designated the head edge 16 because it is located proximate to the head board 72 where the head 28 of the user is generally located. The toe edge 18 is so designated because it is located proximate to a foot board 74 where the feet of the user 26 are positioned. However, some beds 66 will not include a head board 72 and/or foot board 74. The head edge 16 may thus be located proximate to the portion of the bed 66 where the user's head 28 is located. It is to be understood that the bed sheet 12 can be a fitted bed sheet so that the edges 16, 18, 20 and 22 are located just below an upper surface of a mattress 42 since portions of the bed sheet 12 will wrap around the mattress 42 in order to be retained onto the mattress 42. As such, the edges 16, 18, 20 and 22 may not be in the same plane as the central portion of the upper surface 14 of the bed sheet 12. However, in accordance with other exemplary embodiments, the bed sheet 12 can be provided so that the edges 16, 18, 20 and 22 lay in the same plane as one another and are also located in the same plane as the rest of the bed sheet 12.

Bed sheets 12 are generally made so that one side is longer than the other to result in a rectangular shape. In the embodiment shown, the side edges 20 and 22 are longer than the head and toe edges 16 and 18. The head edge 16 has a midpoint 30 that is located halfway between the first side edge 20 and the second side edge 22. The toe edge 18 has a midpoint 32 that is located halfway between the first side edge 20 and second side edge 22. A longitudinal centerline 34 of the bed sheet 12 extends between the midpoints 30 and 32. In a similar fashion, the first side edge 20 has a midpoint 36 located halfway between the head edge 16 and the toe edge 18, and the second side edge 22 has a midpoint 38 located halfway between the edges 16 and 18. A lateral centerline 40 of the bed sheet 12 extends between midpoints 36 and 38. In other arrangements, the edges 16, 18, 20 and 22 need not have different lengths but may all have the same length. Further, the edges 20 and 22 may be shorter than edges 16 and 18 in other embodiments. In these embodiments, the longitudinal centerline 34 is still located so as to extend proximate to the headboard 72 and thus be arranged in the general direction of the length of the user's body when using the bed 66.

Head indicating indicia 24 is located on the upper surface 14 of the bed sheet 12 in order to instruct the user 26 as to which side of the bed sheet 12 is the upper surface 14 when making up the bed 66. Further, the head indicating indicia 24 instructs the user 26 as to which edge of the bed sheet 12 should be located proximate to the head board 72, or when no head board 72 is present then which edge should be located proximate to the head of the bed 66. Further, in some embodiments the head indicating indicia 24 is located at a position that is vertically directly below the location of the head 28 of the user 26 thus providing the user 26 with a reference point as to where to locate pillows 76 or other objects when making up the bed 66. The head indicating indicia 24 is shown as a letter “H” having a design located therein. However, it is to be understood that this arrangement is only exemplary and that head indicating indicia 24 can be variously configured in accordance with other exemplary embodiments. For example, the head indicating indicia 24 may be any letter, symbol, design, or combination thereof in accordance with different exemplary embodiments. The head indicating indicia 24 only need be capable of instructing the user as to the identification of the upper surface 14 and associated information previously discussed in accordance with certain exemplary embodiments.

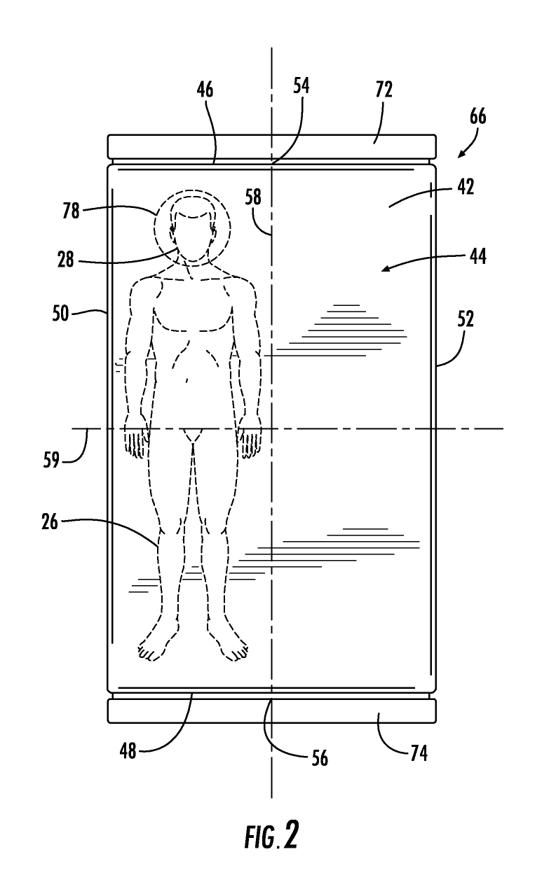

A mattress 42 that can be incorporated into the head placement system 10 is shown with reference to FIG. 2. The mattress 42 has an upper surface 44 that is bound and defined by a head edge 46, toe edge 48, first side edge 50, and second side edge 52. The upper surface 44 faces towards the ceiling of the room into which the bed 66 is located. The head edge 46 is located proximate the head board 72 of the bed 66, and the toe edge 48 is located next to the foot board 74. In arrangements in which the head board 72 is not present, the head edge 46 is located at the head of the bed 66, and the toe edge 48 is located at the portion of the bed 66 where the feet of the user 26 are generally positioned. During use, a user 26 will be positioned above the upper surface 44 and the user's head 28 will be located above a location of the upper surface 44 designated by reference number 78. The upper surface includes a longitudinal centerline 58 that extends from a midpoint 54 of the head edge 46 to a midpoint 56 of the toe edge 48. The longitudinal centerline 58 extends in the general direction that the body of the user 26 will be oriented during use of the bed 66. A lateral centerline 59 bisects the longitudinal centerline 58 and extends through the midpoints of the side edges 50 and 52

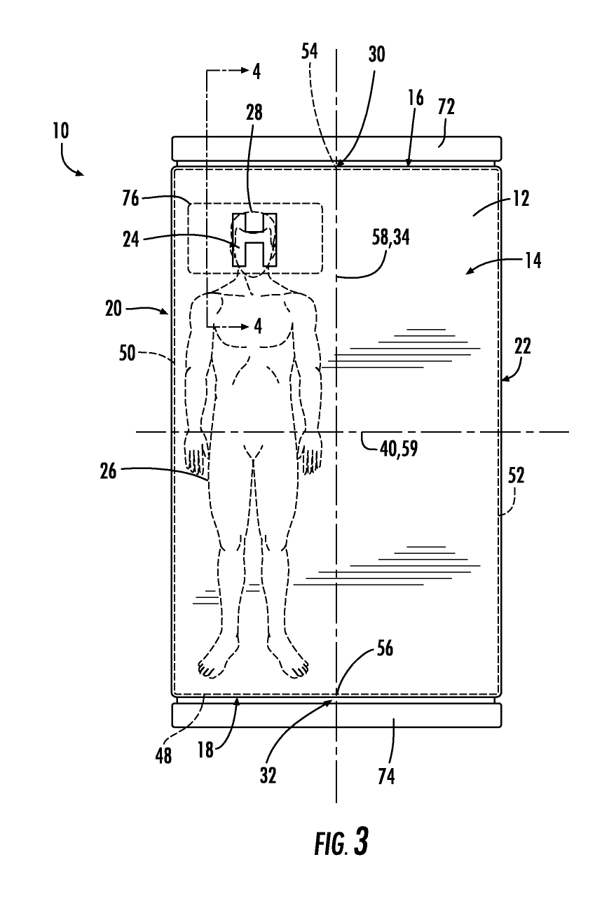

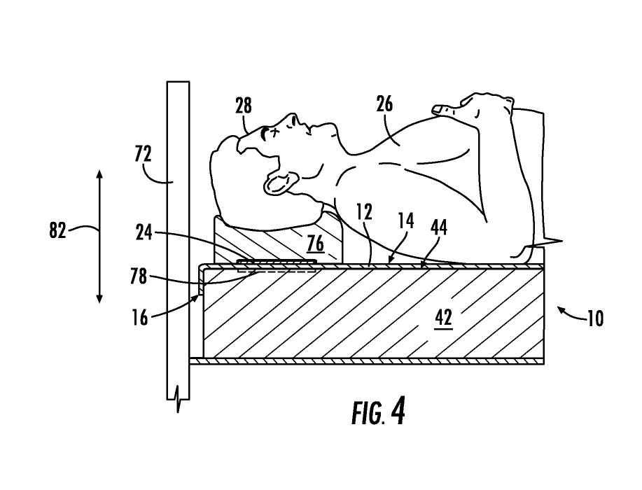

The bed sheet 12 can be placed on top of the mattress 42 as illustrated in FIGS. 3 and 4. The vertical direction 82 is denoted by reference number 82 in FIG. 4. The bed sheet 12 is a bottom sheet and directly contacts the upper surface 44 of the mattress 42. However, it is to be understood that the bed sheet 12 need not directly contact the upper surface 44 in other embodiments. For example, a mattress pad can be located between the upper surface 44 and the bed sheet 12 in other embodiments so that these two components do not directly contact one another. The bed sheet 12 can be arranged with respect to the mattress 42 so that the longitudinal centerlines 34 and 58 overlie one another, and so that the lateral centerlines 40 and 59 likewise are aligned with one another. However, in other arrangements only the longitudinal centerlines 34 and 58 overlie one another while the lateral centerlines 40 and 59 do not overlie one another. The head indicating indicia 24 is located on the upper surface 14 of the bed sheet 12 and is directly contacted by a pillow 76. The head 28 of the user 26 rests on the pillow 76. As such, the head 28 does not directly contact the head indicating indicia 24. The head indicating indicia 24 is located vertically between the head 28 and the bed sheet 12. In this exemplary embodiment, the head 28 is located vertically directly above the head indicating indicia 24 during use of the bed 66 when sleeping. The location 78 of the mattress 44 is likewise vertically located directly under the head 28 when the user 26 uses the bed 66. The head indicating indicia 24 may be spaced from the longitudinal centerlines 34 and 58 some distance so that the head indicating indicia 24 is not located on the longitudinal centerlines 34 and 58. The pillow 76 may be located directly above the head indicating indicia 24 during use of the bed 66, and may be located directly above the head indicating indicia 24 upon making up the bed 66 but before use of the bed 66 when sleeping. In other arrangements, the head 28 of the use 26 can directly contact the head indicating indicia 24 when using the bed 66 while sleeping.

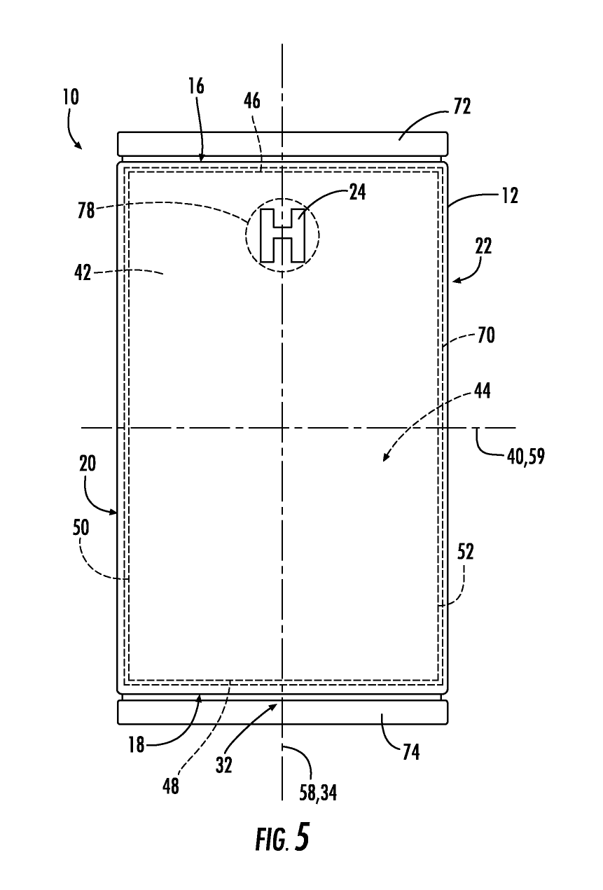

FIG. 5 illustrates an alternative exemplary embodiment in which the bed sheet 12 is a top sheet of the bed 66. The head indicating indicia 24 may thus be visible upon making up the bed 66, although it is to be understood that an additional cover or pillows 76 could be placed onto the head indicating indicia 24 to obscure same after making up the bed 66. The bed 66 includes a bottom sheet 70 that is located on top of and directly contacts the upper surface 44. Location 78 signifies a portion of the mattress 44 above which the head 28 of the user 26 will be located during use of the bed 66. The head indicating indicia 24 is located directly above the location 78 when the bed sheet 12 is placed onto the bed 66 when the bed 66 is made. During use of the bed, the user 26 may pull the bed sheet 12 down and position himself or herself between the sheet 12 and bottom sheet 70. As such, the head indicating indicia 24 will not be located above the head 28 of the user 26 during use of the bed 66. However, the head indicating indicia 24 will be located above location 78 when the bed sheet 12 is placed into the position when the bed 66 is made. The head indicating indicia 24 may thus function to demarcate the appropriate orientation of the bed sheet 12 with respect to the head of the bed as previously discussed.

The head indicating indicia 24 may be located up to 3 feet from the head edge 16. In other arrangements, the head indicating indicia 24 may be located from 3 to 6 inches, from 6 to 12 inches, from 1 foot to 2 feet, or up to 5 feet from the head edge 16. Further, the head indicating indicia 24 may be located on the longitudinal centerline 34 or may be spaced up to 6 inches, from 6 inches to 12 inches, up to 2 feet, or up to 5 feet from the longitudinal centerline 34.

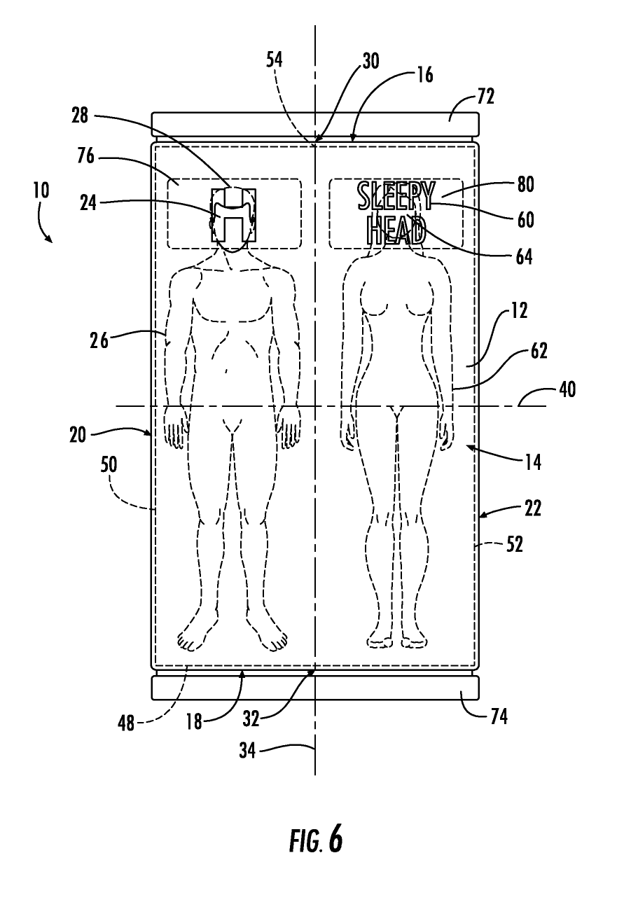

FIG. 6 illustrates an alternative exemplary embodiment in which a second head indicating indicia 60 is located on the upper surface 14 of the bed sheet 12. The first indicating indicia 24 can be used to designate the location of the head 28 of the user 26 in the manner previously discussed. The second head indicating indicia 60 may likewise be positioned on the upper surface 14 so as to designate the location of the head 64 of the second user 62 when using the bed 66. In different arrangements, the second head indicating indicia 60 may be used to designate the location of the bed sheet 12 when made up such that this location is directly vertically above a portion of the mattress 42 that is directly vertically below the head 64 of the second user 62 when the second user 62 is sleeping in the bed 66. The second head indicating indicia 60 can be used and configured in a manner similar that of the first head indicating indicia 24 as discussed above and a repeat of this information is not necessary.

The second head indicating indicia 60 can be spaced a distance from the longitudinal centerline 34 such that the indicia 60 is not located on the longitudinal centerline 34 and such that the indicia 24 and 60 are on opposite sides of the longitudinal centerline 34. The indicia 60 may be located the same distance from the head edge 16 as the first indicia 24, or the second head indicating indicia 60 may be located a different distance from the head edge 16 than the first head indicating indicia 24. The indicia 24 and 60 can both be used to ascertain the upper surface 14 of the bed sheet 12 and to properly orient the bed sheet 12 with respect to the head of the bed 66. Further, the indicia 24 and 60 may include symbols, letters, or pictures that are different from one another so that each indicia 24 and 60 designates a particular user 26 and 62. As such, one will know when making up the bed 66 where to put the particular pillows 76 or 80 that correspond to the particular user 26 and 62 thus allowing the bed 66 to be made up and used in a more efficient manner.

The head indicating indicia 24 can be located in the head placement system 10 so that the head indicating indicia 24 is visible when viewing the bed 66 and/or is located vertically directly above the upper surface 44 of the mattress 42 when the bed sheet 12 is located on the bed 66. Although described as being visible, in other arrangements a cover, blanket, pillow or other object may be placed on top of the head indicating indicia 24 upon making up the bed 66 thus obscuring the head indicating indicia 24 from sight once the bed 66 is made up after use. However, it is to be understood that other arrangements are possible in which the head indicating indicia 24 is visible even after the bed 66 is made.

The head placement system 10 may be constructed by first providing a bed sheet 12 that has an upper surface 14. The bed sheet 12 may be a fitted bed sheet or a flat bed sheet or may be a symmetrical or non-symmetrical bed sheet. The user can next place the bed sheet 12 onto the mattress 42 or bed 66 in the proper manner or orientation upon making up the bed 66. If the bed sheet 12 is a bottom sheet, the bed sheet 12 can be placed onto a mattress 42 in its normal position. If the bed sheet 12 is a top sheet, the bed sheet 12 can be placed onto the bottom sheet 70 or other part of the bed 66 as one would normally do when making up the bed 66 so that the bed sheet 12 is in the position it would normally be in when the bed 66 is made up. When the bed sheet 12 is a top sheet, the bed sheet 12 is not covered by pillows, blankets, or other portions of the bed 66.

Next, the user 26 may mark a location on the bed sheet 12 where the head 28 of the user 26 will be positioned when sleeping. The marked location may be vertically directly above the portion 78 of the upper surface 44 of the mattress 42 where the head 28 of the user 26 will be located when sleeping. The location marked on the bed sheet 12 will thus be proximate to the head of the bed 66. The marking by the user 26 may be made in a variety of manners. For example, the user 26 may use a piece of notepaper having weakened adhesive, or a pencil dot indicator to designate the desired location. In other arrangements, the marking may be just a visual notation by the user 26 without any physical placement or touching of the bed sheet 12. As such, the marking may be either physically marking the location on the bed sheet 12 or marking by just visually noting the desired location.

The user may then remove the bed sheet 12 from the bed and affix the head indicating indicia 24 onto the marked location on the top surface of the bed sheet 12. If a physical marker was applied to the bed sheet 12, the physical marker may or may not be removed before the affixing step. The head indicating indicia 24 may be a decal or appliqué that has adhesive backing. The appliqué or decal may be peeled off of backing paper and then ironed onto the bed sheet 12. The adhesive backing and heat from the iron, or from some other heat producing mechanism, will cause the head indicating indicia 12 to be retained onto the bed sheet 12.

In other embodiments, the head indicating indicia 24 may be an emblem or a design printed on transfer paper. There is no adhesive backing in this instance. The transfer paper and emblem or design are located against the bed sheet and heat and pressure from an iron or other process is used to cause the emblem or design to be transferred onto the bed sheet 12. In this regard, the user 26 can place the bed sheet 12 onto a hard surface or under a pillowcase or similar article located between the bed sheet 12 and the hard surface. The user may then properly locate the transfer paper onto the marked location on the bed sheet 12 and apply an iron, with or without steam, to the transfer paper. The transfer paper can then be removed and the head indicating indicia 24 will be properly affixed to the upper surface 14 of the bed sheet 12 at the desired location. The head indicating indicia 24 may be made of 100% organic cotton material and may be bonded with machine washable adhesives to ensure proper attachment after multiple laundry cycles. In other arrangements, the head indicating indicia 24 may be a synthetic material, or may be a combination of synthetic and organic materials. Although described as being removed from the bed 66 in order to affix the head indicating indicia 24 thereon, the bed sheet 12 need not be removed from the bed 66 in other embodiments and the head indicating indicia 24 may be affixed to the upper surface 14 while the bed sheet 12 is located on the bed 66.

Although described as being located directly vertically below the head 28 of the user 26, the head 28 need not be actually located directly vertically above the head indicating indicia 24 in certain exemplary embodiments. In these instances, the head indicating indicia 24 will be at least proximately located directly under the head 28 of the user 26 so that the proper orientation of the bed sheet 12 with respect to the bed 66 can be realized. This arrangement is also true should the bed sheet 12 be a top sheet. Here, the location 78 of the upper surface 44 of the mattress 42 is not located vertically directly under the head 28 of the user 26 when sleeping but is located proximately directly vertically under the head 28. However, the location 78 is still located vertically directly under the head indicating indicia 24 when the bed 66 is made. The head 28 of the user 26 may be located directly above a portion of the upper surface 14 of the bed sheet 12 that is up to 6 inches, from 6 to 12 inches, or up to 2 feet from the head indicating indicia 24. As such, the head 28 of the user 26 may be located some distance from the head indicating indicia 24 so as not to be located completely vertically above the head indicating indicia 24 in certain embodiments. The head indicating indicia 24 may thus be spaced from all of the edges 16, 18, 20 and 22 of the bed sheet 12 such that the head indicating indicia 24 is not located along any of the edges. Further, the head indicating indicia 24 may be a single piece of indicia and not multiple pieces of indicia in certain exemplary embodiments. Further, markings or indicia need not be made on any other portions of the bed 66, such as the head board 72 or foot board 74. The entire applied indicia may be limited to only the upper surface 14 of the bed sheet 12 and no other portion of the bed 66.

The head placement system 10 may be an aftermarket item in that the head placement system 10 can be used with bed sheets 12 of any make or manufacture. However, in certain embodiments the head indicating indicia 24 can be applied by a manufacturer of the bed sheet 12 and be sold to a consumer with the indicia 24 all ready applied thereon. The head placement system 10 can be used by children who are first learning to make their beds. Also, elderly who may have various medical frailties may also benefit upon use of the head placement system 10 as it will facilitate easier making of their beds. Additionally, other people will likewise benefit such as those having arthritis and eyesight impairment or individual with other physical handicaps or learning differences. For example, the fact that the head indicating indicia 24 may be raised above the upper surface 14 since it is located on the upper surface 14 may allow a blind person to feel the head indicating indicia 24 and allow him or her to properly position the bed sheet 12 on the bed 66. However, it is to be understood that the head placement system 10 can be used by any person making up a bed 66 and is not so limited to a particular type of user.

Although described as a head placement system 10, the system 10 can be a user placement system 10 and used in relation to other portions of the user 26 besides the head 28 of the user 26. For example, the user placement system 10 can be used so that the user indicating indicia 24 is located so as to designate the location of the heart, the left hand, the right hand, the small of the back, the neck, the left leg, the right leg, or the stomach of the user 26 in accordance with various exemplary embodiments. Of course, the user placement system 10 may be a head placement system 10 that is used to designate the location of the head 28 of the user 26 when using the system 10 as previously discussed. However, it is to be understood that the user placement system 10 may be used to designate the location of more than just the head 28 in other arrangements. In still other exemplary embodiments, the user placement system 10 can be used to designate multiple portions of the user 26 such as the head 28 and feet, the heart and small of the back, and/or the neck and legs. The user indicating indicia 24 may be used to designate the approximate location of the entire body of the user 26 in other embodiments. The user indicating indicia 24 allows one to correctly make up the bed so that the bed sheet 12 is placed right side up and so that it is properly oriented with respect to the head board 72 or foot board 74. Further, the user indicating indicia 24 provides a reference point as to where the particular portion of the user's 26 body will be located when sleeping on the bed 66. The reference point may be the actual location of the body part, or may be an approximate location of the body part.

The term user indicating indicia 24 may include the term head indicating indicia 24 and discussion made to head indicating indicia 24 may be similarly applied to the term user indicating indicia 24 and a repeat of this information is not necessary. Also, the same holds true with the term user placement system 10 that may include the term head placement system 10 so that discussion made regarding the head placement system 10 may be applicable to the term user placement system 10 and a repeat of this information is not necessary. The terms head placement system 10 and head indicating indicia 24 may be simply terms of convenience to describe one exemplary embodiment of the system 10 and indicia 24 and it is to be understood that these terms may be inclusive of the terms user placement system 10 and user indicating indicia 24 discussion relevant to these terms may be attributable to the other.

The user indicating indicia 24 may be carried by the bed sheet 12 and can be located at any portion of the bed sheet 12. The user indicating indicia 24 may be located on the upper surface 14 of the bed sheet 12 as previously discussed with reference to FIG. 4. The user indicating indicia 24 can be carried by the bed sheet 12 so as to be located at various locations on the bed sheet 12. For example, with reference to FIG. 7, the user indicating indicia 24 is carried by the bed sheet 12 so as to be located on a lower surface 15 of the bed sheet 12. The lower surface 15 is a portion of the bed sheet 12 that faces away from the user 26 when the user 26 lies on the bed sheet 12 during use. The lower surface 15 may engage the top surface of the mattress 42 when the bed sheet 12 functions as a bottom sheet and engages the mattress 42. The bed sheet 12 may be made out of a material that allows one to see the user indicating indicia 24 through the material making up the bed sheet 12. The bed sheet 12 may be made out of a material that is opaque enough so that it does not allow one to see the user indicating indicia 24 through the upper surface 14. In these instances, the user 26 may simply orient the user indicating indicia 24 down towards the mattress 42.

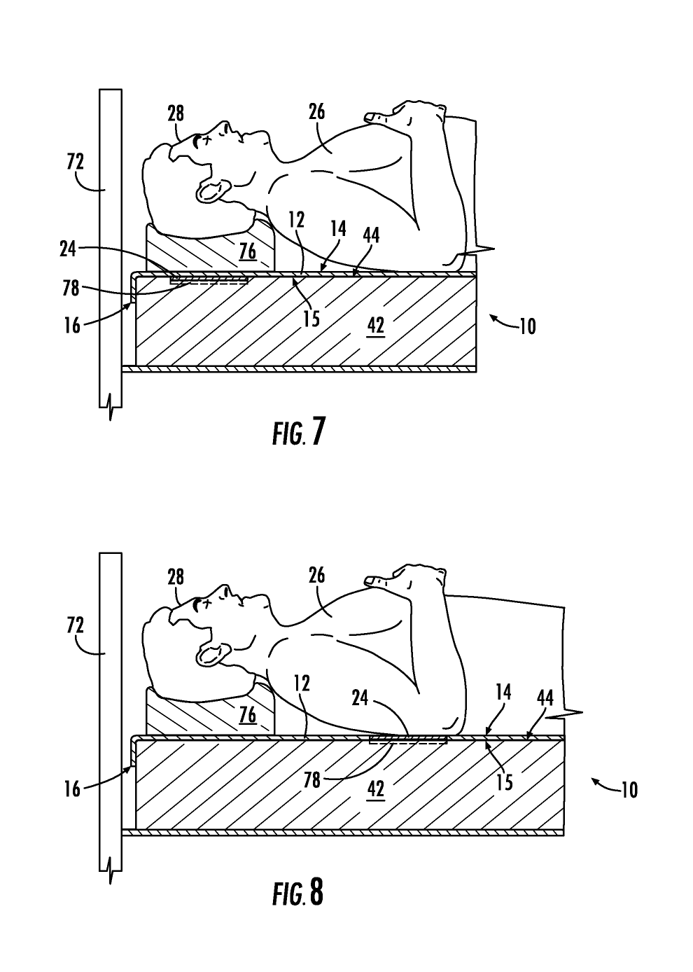

FIG. 8 shows another embodiment in which the user indicating indicia 24 is not located on either the upper surface 14 or the lower surface 15. Instead, the user indicating indicia 24 is located between the upper and lower surfaces 14 and 15 so that it is essentially located inside of the bed sheet 12. The bed sheet 12 may be made of a material that allows the user 26 to see the location of the user indicating indicia 24 so that the bed sheet 12 can be properly oriented. Further, as shown in FIG. 8, the user indicating indicia 24 is used to designate the location of the heart of the user 26 when sleeping on the bed 66.

Although described as being on the upper surface 14, lower surface 15, or between the upper and lower surfaces 14 and 15, the user indicating indicia 24 may be located at any combination of these locations in other embodiments. For example, the user indicating indicia 24 may be made of two components one of which is located on the upper surface 14 and the other of which is located on the lower surface 15. In another embodiment, the user indicating indicia 24 may be located both on the upper surface 14 and into the bed sheet 12 so that some portion is within the interior of the bed sheet 12. In still other embodiments, the user indicating indicia 24 may be a separate component that fill in an aperture of the bed sheet 12 so that it is not actually located on the upper surface 14, lower surface 15, or between the upper and lower surfaces 14 and 15. In such instances, the user indicating indicia 24 is still carried by the bed sheet 12 because it engages the bed sheet 12 or is otherwise attached to or associated with the bed sheet 12 in some manner. As such, the user indicating indicia 24 may be located at any portion of the bed sheet 12, may be made of one or more components, and may be carried by the bed sheet 12 in a variety of manners in accordance with various exemplary embodiments.

The bed sheet 12 may be any sheet associated with a bed 66 such as a bottom sheet, top sheet, blanket, cover, pillow case, or quilt. The bed sheet 12 may be any item used in connection with a bed 66 that a user 26 desires to orient and/or locate with respect to the bed 66.

The user indicating indicia 24 can be carried by the bed sheet 12 in a variety of manners. For example, the user indicating indicia 24 may be integrally formed with the bed sheet 12 so that it in effect makes up part of the bed sheet 12. Such integral formation may be accomplished by making the user indicating indicia 24 a piece of yarn, thread or ribbon that forms a part of the bed sheet 12. The yarn, thread or ribbon may be colored differently than the surrounding portions of the bed sheet 12 so that the user 26 can ascertain the location of the user indicating indicia 24. The user indicating indicia 24 could alternatively be stitching and/or embroidery that is placed onto the bed sheet 12 that is not part of the bed sheet 12 but rather attached to it that a user can identify so that the user indicating indicia 24 is properly distinguished. The stitching and/or embroidery can be the same color as the rest of the bed sheet 12 or may be a different color in order to further accentuate the location of the user indicating indicia 24.

As stated, the user indicating indicia 24 can be carried by the bed sheet 12 in any number of manners. The user indicating indicia 24 may be integrally formed with the bed sheet 12, or may be a separate component that is attached to the bed sheet 12. The user indicating indicia 24 may be a separate component such as ink or wax that is applied to the bed sheet 12 in order to print the user indicating indicia 24 onto the bed sheet 12 or otherwise cause it to be retained thereon. The user indicating indicia 24 may be an iron-on patch that the user 26 applies to the bed sheet 12 through the use of heat and pressure. The user indicating indicia 24 may be a patch that is applied to the bed sheet 12 with adhesion, mechanical fasteners, sewing, or hook and loop type fasteners to be carried by the bed sheet 12. It is to be understood that the user indicating indicia 24 can be carried by the bed sheet 12 in a variety of ways in accordance with various exemplary embodiments and that the disclosed manners are only exemplary and that others are possible.

Further, the user indicating indicia 24 may be applied by a user 26 that is a consumer that purchases the bed sheet 12 separately from the user indicating indicia 24. The user 26 may himself or herself apply the user indicating indicia 24 to the bed sheet 12 once both of these items are in his or her home. Alternatively, the user indicating indicia 24 may be applied by a manufacturer, store owner, or retailer to the bed sheet 12 so that the user 26 purchases the user placement system 10 at one time without having to himself or herself apply the user indicating indicia 24 to the bed sheet 12. The user indicating indicia 24 may be applied by the user 26 or by any other entity or person in accordance with various embodiments. Further, the user indicating indicia 24 may be applied by a combination of the user 26, manufacturer, or other entity or person in accordance with yet further embodiments such that no one actor himself or herself performs all of the application.

The user indicating indicia 24 may be applied to the bed sheet 12 so as to be carried by the bed sheet 12 through a digital fabric printing method. One such method is digital printing in which a print head is used to apply micro-sized droplets of ink or dye directly onto the upper or lower surfaces 14, 15 of the bed sheet 12. The digital fabric printing method may be dye sublimation which is a reactive process where dye is placed under intense heat and pressure, and converted into a gas without becoming liquid, revealing brilliant colors onto fabrics. An additional digital fabric printing method that can be employed may be colorfast digital printing which is a reactive process requiring dye and heat application resulting in vibrant colors.

Another way of applying the user indicating indicia 24 to the bed sheet 12 so that the user indicating indicia 24 is carried by the bed sheet 12 is by way of an ink application method. The ink application method may be screen printing which is sometimes known as silk screen printing or serigraphy. Screen printing is a stencil process in which a design is superimposed on a mesh screen. The stencil blocks some areas of ink and may include non-permeable material. The stencil defines portions of the woven mesh through which ink can be transferred onto the bed sheet 12 and ink can be forced past the fabric of the mesh in open areas of the mesh to effect printing of the user indicating indicia 24 to the bed sheet 12. Another type of ink application method may be pad printing that is sometimes known as transfer pad printing. This method uses a flexible rubber pad to draw ink from a template. The ink on the flexible rubber pad may then be applied to the bed sheet 12 to form the user indicating indicia 24. A further example of an ink application method may be fabric stamping in which a die that includes ink is pressed onto the bed sheet 12 in order to form the user indicating indicia 24. Ink applied to the bed sheet 12 may be thought of as being attached to the bed sheet 12. The ink may not soak into the fabric of the bed sheet 12 and is attached to the bed sheet 12 via heat. It is to be understood that other types of fabric stamping need not employ heat and that this method may be used to form the user indicating indicia 24 without the use of heat. The ink may produce sharp images on the bed sheet 12 and may be embossed which can be felt by the user 26 running his or her hand over the location of the user indicating indicia 24.

Additional forms of the ink application method may exist in blotch printing in which the background color and design are printed onto the bed sheet 12 which may have a lower surface 15 that is typically white. Another type of ink application method may be found in electrostatic printing in which the various colors making up the user indicating indicia 24 are printed by use of an electrostatic charge that pulls the dye-resin mixture to the bed sheet 12. A still further ink application method may be found in thermal printing in which wax based ink is first provided on a piece of paper or other substrate. The paper may pass over a thermal print head that causes the wax based ink to melt onto the bed sheet 12. A still further type of ink application method may be found in rotary screen printing or flat screen printing (based on the type of screen used), in which a printing paste or dye is poured onto flat or cylindrical screens and is forced through its unblocked areas onto the bed sheet 12. A still further form of an ink application method that can be used to cause the user indicating indicia 24 to be carried by the bed sheet 12 is spray jet printing in which a spray nozzle individually applies ink directly onto the bed sheet 12. Another way of conducting the ink application method is via tagless printing in which ink is placed onto a die or other member and then pressed onto the bed sheet 12, that may be without the use of heat, so that the ink is transferred onto the bed sheet 12 to form the user indicating indicia 24.

A still further form of an ink application method that can be used to cause the user indicating indicia 24 to be carried by the bed sheet 12 is block printing in which a design is carved onto a wooden or metal block. Ink is applied to the design on the face of the block. The block is pressed down firmly by hand onto the surface of the bed sheet 12 to effect transfer of ink.

A still further form of an ink application method that can be used to cause the user indicating indicia 24 to be carried by the bed sheet 12 is Perrotine printing which consists of three large blocks with the pattern/design cut or cast on them in relief. Color is distributed and the impression of the user indicating indicia 24 is impressed onto fabric with a precision practically impossible in hand printing.

A still further form of an ink application method that can be used to cause the user indicating indicia 24 to be carried by the bed sheet 12 is stencil printing in which a pattern is cut out of a sheet of stout paper or thin metal, the uncut portions representing the part that is to be left uncolored. The sheet of paper is laid onto the bed sheet 12 and color is brushed through its interstices.

A still further form of an ink application method that can be used to cause the user indicating indicia 24 to be carried by the bed sheet 12 is roller printing in which engraved copper cylinders or rollers are used. With each revolution of the roller, a repeat of the design is printed. The printed bed sheet is passed into a drying and then a steam chamber where the moisture and heat sets the dye.

A still further form of an ink application method that can be used to cause the user indicating indicia 24 to be carried by the bed sheet 12 is duplex printing in which printing is done on both sides of the bed sheet 12 either through a roller printing machine in two operations or a duplex printing machine in a single operation.

A still further form of an ink application method that can be used to cause the user indicating indicia 24 to be carried by the bed sheet 12 is direct to garment printing in which the indicating indicia 24 is produced by imprinting dye on the bed sheet 12 in a paste form. The indicating indicia 24 can be carried on a white or colored fabric.

A still further form of an ink application method that can be used to cause the user indicating indicia 24 to be carried by the bed sheet 12 is lithographic printing in which the user indicating indicia 24 is rendered on a metal or stone surface which is treated to retain ink while non-image areas are treated to repel ink and can be printed directly onto the bed sheet 12 from the stone plate or can be offset printed.

An additional method of causing the user indicating indicia 24 to be carried by the bed sheet 12 is a heat transfer method. The heat transfer method may employ a transfer member such as an iron-on label, appliqué, design on transfer paper, or thermal transfer label. Heat and pressure is applied to the transfer member in order to cause the user indicating indicia 24 to be bonded to the bed sheet 12. The heat and pressure may be applied by a user 26 through the application of a hot iron. The heat transfer method may employ tagless heat transfer labels, or employ thermal transfer labels in certain exemplary embodiments. Another heat transfer method that can be used makes use of a heat press. A transfer member with a design is provided and is pressed onto the bed sheet 12 through the use of a machine that applies heat and pressure to effect transfer. In other arrangements, the user indicating indicia 24 can be applied to a fabric that is in turn subsequently sewn or otherwise attached to the bed sheet 12. Another heat transfer method may be heat transfer printing in which the user indicating indicia 24 is preprinted on rolls of paper. Heat transfer printing machines may be used to effect transfer of the user indicating indicia 24 from the rolls to the bed sheets 12.

A still further form of heat transfer method that can be used to cause the user indicating indicia 24 to be carried by the bed sheet 12 is wet heat transfer printing which uses heat in a wet atmosphere for vaporizing the dye pattern from paper to the bed sheet 12.

The user indicating indicia 24 may be applied to the bed sheet 12 to be caused to be carried by the bed sheet 12 via a dyeing process. The dye can be absorbed into the fabric making up the bed sheet 12 so that the fibers making up the bed sheet 12 are in fact altered. The bed sheet 12 can be prepped with folds or wax to resist the dye. The user 26 may not be able to feel the indicating indicia 24 when formed from a dyeing process.

A still further dyeing application method that can be used to cause the user indicating indicia 24 to be carried by the bed sheet 12 is resist printing in which a resist paste is imprinted onto the bed sheet 12 and then is dyed. The dye affects only those parts that are not covered by the resist paste. After dyeing, the resist paste is removed leaving the user indicating indicia 24 on a dark background.

A still further form of a dyeing application method that can be used to cause the user indicating indicia 24 to be carried by the bed sheet 12 is direct dyeing in which a dye is applied directly to the fabric without the aid of an affixing agent.

A still further form of a dyeing application method that can be used to cause the user indicating indicia 24 to be carried by the bed sheet 12 is yarn dyeing in which dyeing is done after the fiber has been spun into yarn and may include forms of yarn dyeing such as skein dyeing, package dyeing, warp-beam dyeing, and space dyeing.

A still further form of a dyeing application method that can be used to cause the user indicating indicia 24 to be carried by the bed sheet 12 is silk printing in which acid and dyes play a major role. Acid dyes can be discharged or reserved effects can be produced by printing mechanical resists.

Additional methods of causing the user indicating indicia 24 to be carried by the bed sheet 12 may include discharge printing in which a chemical is applied to the bed sheet 12 to remove coloring so that blank areas, such as a white portion, are left to form the user indicating indicia. In addition, “colored” discharge printing replaces the discharged color with another shade. Another way of causing the user indicating indicia 24 to be carried may be a thermal wax method in which wax or resin is used. Different colors can be applied directly to the bed sheet 12 through the use of a roller. Additional methods include stamping of the user indicating indicia 24 to the bed sheet 12.

A still further application method that can be used to cause the user indicating indicia 24 to be carried by the bed sheet 12 is warp printing in which a roller printer is applied to warp yarns before they are woven into the fabric.

A still further application method that can be used to cause the user indicating indicia 24 to be carried by the bed sheet 12 is pigment printing which is the direct application of color onto fabric using pigment inks.

A still further application method that can be used to cause the user indicating indicia 24 to be carried by the bed sheet 12 is photo printing in which the bed sheet 12 is coated with a chemical that is sensitive to light and then any photograph or image may be printed on it.

Additional methods of causing the user indicating indicia 24 to be carried by the bed sheet 12 may include embossing, which also can be known as textile embossing, blind printing, and relief printing in which images, designs, decorations and patterns are created on the surface of the user indicating indicia 24, bed sheet 12, and or other fabric through the application of heat and pressure, thus changing the nature of the material. During the process of embossing, the surface of the embossed material raises, adding a new dimension to the object. Additional forms of embossing may include but are not limited to blind emboss, tint emboss, single level emboss, multi level emboss, printed emboss, registered emboss, glazing.

Blind emboss is where the embossed image and the fabric's surface are the same. Tint emboss uses a pastel or pearl foil. Single level emboss is performed in which the image area is raised to one flat level. Multi Level Emboss is performed in which the embossed image is raised to different levels giving a depth to the embossing. Printed emboss is another method of embossing in which the embossed part registers with a printed image. Registered emboss is where the printed image is embossed to give a raised look. Glazing is yet another method of embossing in which a polished emboss is used on dark colored surfaces with the application of additional heat and pressure to give a shine to the fabric's surface.

Although certain ways of causing the user indicating indicia 24 to be carried by the bed sheet 12 have been disclosed, it is to be understood that these ways are not a comprehensive, exhaustive list but that other ways are possible. The previously described ways of causing the user indicating indicia 24 to be carried by the bed sheet 12 are only exemplary and others are possible in accordance with other exemplary embodiments. Further, in still other arrangements, more than one of the mentioned ways may be employed in order to cause the user indicating indicia 24 to be carried.

Although the user indicating indicia 24 may be applied to the bed sheet 12 by only one of the previously described processes, combinations of two or more of the previously described processes may also be used. Further, the indicating indicia 24 may be applied to the bed sheet 12 by processes not explicitly stated herein.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A user placement system for a bed, comprising:
a bed sheet having an upper surface, wherein the bed sheet has a head edge on one end and a toe edge on an opposite end, wherein the bed sheet has a first side edge that extends from the head edge to the toe edge, and wherein the bed sheet has a second side edge that extends from the head edge to the toe edge; and
a user indicating indicia carried by the bed sheet, wherein the user indicating indicia designates an approximate location where a portion of a user is located when sleeping on the bed.

2. The user placement system as set forth in claim 1, wherein the user indicating indicia is located on the upper surface of the bed sheet, wherein the bed sheet is a bottom sheet and wherein the head of the user is located directly vertically above the user indicating indicia such that the user indicating indicia is located between the bed sheet and the head of the user such that the user indicating indicia is a head indicating indicia.

3. The user placement system as set forth in claim 1, wherein the user indicating indicia is an iron on emblem, wherein the user indicating indicia is attached to the upper surface of the bed sheet.

4. The user placement system as set forth in claim 1, wherein the user indicating indicia is located on a lower surface of the bed sheet.

5. The user placement system as set forth in claim 1, wherein a longitudinal centerline of the bed sheet is located at the midpoint of the head edge and at the midpoint of the toe edge, wherein the longitudinal centerline extends from the midpoint of the head edge to the midpoint of the toe edge, and wherein the user indicating indicia is spaced from the longitudinal centerline such that the user indicating indicia is not located on the longitudinal centerline.

6. The user placement system as set forth in claim 1, wherein the user indicating indicia is located between the upper surface of the bed sheet and a lower surface of the bed sheet.

7. The user placement system as set forth in claim 1, wherein the user indicating indicia is applied to the bed sheet so as to be carried by the bed sheet by a digital fabric printing method.

8. The user placement system as set forth in claim 1, wherein the user indicating indicia is applied to the bed sheet so as to be carried by the bed sheet by an ink application method.

9. The user placement system as set forth in claim 8, wherein the ink application method is selected from the group consisting of screen printing, pad printing, fabric stamping, block printing, Perrotine printing, stencil printing, roller printing, duplex printing, direct to garment printing, and lithographic printing.

10. The user placement system as set forth in claim 1, wherein the user indicating indicia is applied to the bed sheet so as to be carried by the bed sheet by a heat transfer method using a transfer member.

11. The user placement system as set forth in claim 1, wherein the user indicating indicia is applied to the bed sheet so as to be carried by the bed sheet by dyeing.

12. The user placement system as set forth in claim 1, wherein the user is a customer that purchases the user indicating indicia separately from the bed sheet, and wherein the user attaches the user indicating indicia to the bed sheet such that the user indicating indicia is carried by the bed sheet.

13. The user placement system as set forth in claim 1, wherein the user indicating indicia is integrally formed with the bed sheet, wherein the user indicating indicia is selected from the group consisting of ribbon, sewing, embroidery, surface embroidery, thread, stitching, and yarn.

14. The user placement system as set forth in claim 1, wherein the user indicating indicia designates the location of the head of the user when sleeping on the bed such that the user indicating indicia is a head indicating indicia.

15. A method for providing a user placement system for a bed, comprising the steps of:
providing a bed sheet; and
applying a user indicating indicia to the bed sheet, wherein when the bed sheet is located on the bed before being used by the user the user indicating indicia designates an approximate location of a user when the user sleeps on the bed.

16. The method as set forth in claim 15, wherein the user indicating indicia designates the location of the head of the user when the user sleeps on the bed such that the user indicating indicia is a head indicating indicia.

17. The method as set forth in claim 15, wherein the user indicating indicia is applied to an upper surface of the bed sheet, and wherein the bed sheet is a bottom sheet.

18. The method as set forth in claim 15, wherein the applying step is accomplished by a process selected from the group consisting of digital fabric printing, an ink application method, a heat transfer method, dyeing, discharge printing, and a thermal wax method.

19. The method as set forth in claim 18, wherein the digital fabric printing is selected from the group consisting of dye sublimation, colorfast digital printing, and digital printing;
wherein the ink application method is selected from the group consisting of screen printing, pad printing, fabric stamping, blotch printing, electrostatic printing, thermal printing, rotary screen printing, spray jet printing, flat screen printing, block printing, Perrotine printing, stencil printing, roller printing, duplex printing, direct to garment printing, and lithographic printing;
wherein the heat transfer method is selected from the group consisting of heat pressing with a design printed on a transfer member, wet heat transfer, and thermal transfer with a design printed on an appliqué;
wherein the dyeing method is selected from the group consisting of resist printing, direct dyeing, yarn dyeing that is skein dyeing, yarn dyeing that is package dyeing, yarn dyeing that is warp-beam dyeing, yarn dyeing that is space dyeing, and silk printing.

20. The method as set forth in claim 15, wherein the applying step is accomplished by a process selected from the group consisting of warp printing applied to warp yarns, pigment printing, photo printing, blind emboss, tint emboss, single level emboss, multi level emboss, printed emboss, registered emboss, and glazing.

21. A user placement system for a bed, comprising:
a bed sheet; and
a user indicating indicia carried by the bed sheet, wherein when the bed sheet is located on the bed before being used by the user the user indicating indicia designates a location of a part of the user when the user sleeps on the bed.
